(19) United States
(12) Patent Application Publication
(10) Pub. No.: US 2026/0253818 A1
(43) Pub. Date: Aug. 27, 2026

(54) Toggle type sound and silence switch mechanism for key switch

(71) Applicant: DONGGUAN CITY KAIHUA ELECTRONICS CO.LTD, Dongguan, Guangdong (CN)

(72) Inventor: Fuxi Wu, Dongguan, Guangdong (CN)

(21) Appl. No.: 18/995,407

(22) PCT Filed: Nov. 22, 2023
(86) PCT No.: PCT/CN2023/133269

§ 371 Date: Jan. 16, 2025

(30) Foreign Application Priority Data
Nov. 23, 2022 (CN) 202211476073.9

(51) Int. Cl. H01H 13/20; H01H 13/14

(52) U.S. Cl. CPC H01H 13/20; H01H 13/14; H01H 2215/03

(57) ABSTRACT

The invention discloses a toggle-type audible and silent switching mechanism for a key switch, which comprises a base and a pressing piece which is arranged on the base and can move up and down, wherein a pressing lug is arranged on the pressing piece, a guide inclined plane is formed on the base, and an elastic piece is arranged on the base, and one end of the elastic piece is positioned above the guide inclined plane. Characterized in that a toggle switching assembly is arranged on the base, and the toggle switching assembly comprises a toggle piece arranged on the base and extending to the side of one end of the elastic piece, and the toggle piece is used for driving one end of the elastic piece to switch between being under the pressing lug and being far away from the pressing lug. The toggle-type audible and silent switching mechanism for the key switch disclosed by the invention can realize the switching between the audible and silent pressing functions, meet the different needs of users, improve the use convenience and enhance the user experience.

### TECHNICAL FIELD

The invention relates to the field of key switches, in particular to a toggle-type audible and silent switching mechanism for key switches.

### BACKGROUND

At present, the key switches on the market can be classified into two types: audible key switches and silent key switches. The audible key switches can give users a better feel and sound sense, but the sound they emit will make them more noisy in some situations. Silent key switch will not make sound, which can meet the demand of some users for pressing silence, but the touch of silent key switch is poor.

However, the existing key switch can only realize the function of sound or silence, and can not switch between sound and silence freely according to the needs of users, which brings inconvenience to users, can not meet the different needs of users at the same time, and the user experience is not good.

### SUMMARY OF THE INVENTION

In view of the above shortcomings, the purpose of the present invention is to provide a toggle-type audible and silent switching mechanism for key switches, which can switch between audible and silent pressing functions, meet the different needs of users, improve the convenience of use and enhance the user experience.

The technical scheme adopted by the invention for achieving the above purpose is as follows:

A toggle-type audible and silent switching mechanism for a key switch is characterized by comprising a base and a pressing piece which is arranged on the base and can move up and down, wherein a pressing lug is arranged on the pressing piece, a guide inclined plane is formed on the base, and an elastic piece is arranged on the base, and one end of the elastic piece is positioned above the guide inclined plane. Characterized in that a toggle switching assembly is arranged on the base, and the toggle switching assembly comprises a toggle piece arranged on the base and extending to the side of one end of the elastic piece, and the toggle piece is used for driving one end of the elastic piece to switch between being under the pressing lug and being far away from the pressing lug.

As a further improvement of the invention, the poking piece comprises a longitudinal poking rod at the side of one end of the elastic piece and a linkage swinging rod connected with the longitudinal poking rod.

As a further improvement of the invention, an arc-shaped part is formed at the lower end of the longitudinal shifting rod.

As a further improvement of the invention, a longitudinal slot is formed on the base for inserting and moving the toggle piece, and an arc-shaped swinging slot for embedding the arc-shaped part of the longitudinal toggle lever is formed at the bottom of the longitudinal slot.

As a further improvement of the invention, two opposite side edges of the lower part of the longitudinal shifting lever are respectively formed with a limiting protrusion, and the limiting protrusion is located above the arc part.

As a further improvement of the invention, two opposite sides of the arc-shaped swinging groove are respectively formed with a limiting groove for embedding the limiting protrusion.

As a further improvement of the invention, a yielding inclined plane is formed on one side of the longitudinal shifting lever close to the elastic piece.

As a further improvement of the invention, the whole linkage swing rod is arc-shaped.

As a further improvement of the invention, the toggle switch assembly further comprises a push handle linked with the linked swing rod, a connecting shaft is arranged on the push handle, and a connecting port for inserting and moving the connecting shaft is arranged at the end of the linked swing rod, and the height of the connecting port is greater than the thickness of the connecting shaft.

As a further improvement of the invention, the elastic piece is a torsion spring, and a return spring is arranged between the bottom of the pressing piece and the base.

The invention has the beneficial effects that:
(1) The toggle piece of the toggle switching assembly acts on one end of the elastic piece to adjust the position of one end of the elastic piece, so that one end of the elastic piece is switched between being under the pressing lug and being far away from the pressing lug, so as to realize the switching between the two functions of pressing with sound and pressing without sound, meet the different needs of users, improve the convenience of use and enhance the user experience.
(2) A toggle switch assembly is composed of a toggle piece and a push handle, and the toggle piece is composed of a longitudinal toggle lever and a linkage swing lever. The whole toggle switch assembly has simple structure and principle, is convenient to operate, can accurately control the movement of the elastic piece, and is beneficial to improving the switching accuracy of the two functions of pressing with sound and pressing without sound.

The above is an overview of the technical scheme of the invention, and the invention will be further explained with the attached drawings and specific embodiments.

### DESCRIPTION OF DRAWINGS

FIG. 1 is a schematic structural diagram of the present invention;

FIG. 2 is an exploded view of the present invention;

FIG. 3 is a schematic structural diagram of the toggle piece in the present invention;

FIG. 4 is a schematic structural diagram of the toggle switch assembly in the present invention;

FIG. 5 is a cross-sectional view of a toggle piece arranged on a base in the present invention;

FIG. 6 is an enlarged view of part a in FIG. 5;

FIG. 7 is a cross-sectional view of the toggle switch mechanism applied to the key switch in the present invention;

FIG. 8 is an enlarged view of part b in FIG. 7;

FIG. 9 is a schematic structural diagram of the base in the present invention;

FIG. 10 is a schematic diagram of the external structure of the toggle switch mechanism applied to the key switch in the present invention.

### EMBODIMENTS

In order to further illustrate the technical means and effects adopted by the present invention to achieve the predetermined purpose, the specific embodiments of the present invention will be described in detail with the attached drawings and preferred embodiments.

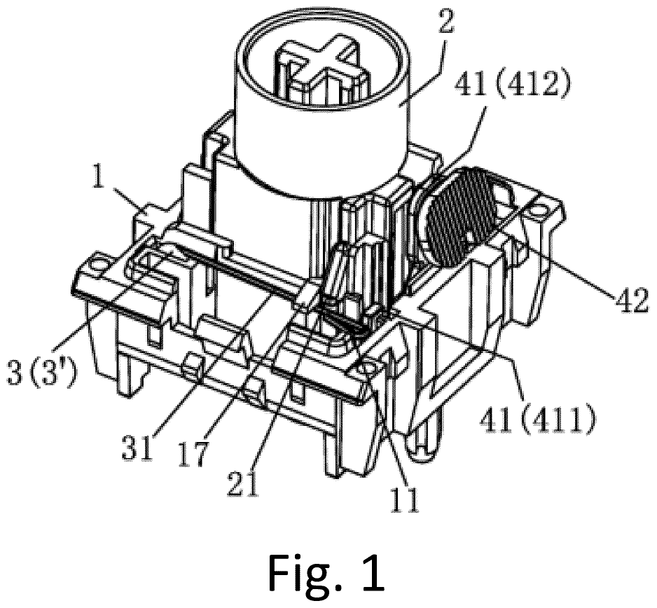

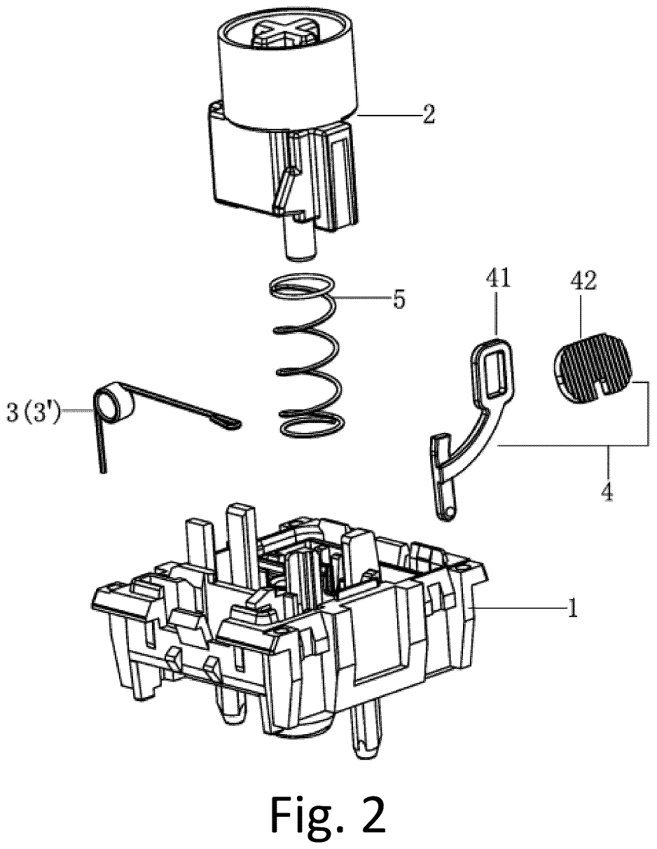

Please refer to FIG. 1 and FIG. 2. An embodiment of the present invention provides a toggle-type audible and silent switching mechanism for a key switch, which comprises a base 1, and a pressing piece 2 which is arranged on the base 1 and can move up and down. A pressing projection 21 is arranged on the pressing piece 2, a guide inclined plane 11 is formed on the base 1, and an elastic piece 3 is arranged on the base 1. One end of the elastic piece 3 is located above the guide inclined plane 11. The base 1 is provided with a toggle switch assembly 4, which comprises a toggle member 41 arranged on the base 1 and extending to the side of one end of the elastic member 3, and the toggle member 41 is used for driving one end of the elastic member 3 to switch between being under the pressing projection 21 and being far away from the pressing projection 21. By pushing the toggle member 41 to act on one end of the elastic member 3, the position of one end of the elastic member 3 is adjusted, so that one end of the elastic member 3 is switched between being under the pressing projection 21 and being far away from the pressing projection 21, so as to realize the switching between pressing with sound and pressing without sound, and meet the different needs of users.

Specifically, when the poking piece 41 is pushed towards the elastic piece 3, the poking piece 41 pushes one end of the elastic piece 3, that is, it pokes one end of the elastic piece 3 away from the pressing bump 21, so that one end of the elastic piece 3 moves away from the pressing bump 21, that is, the elastic piece 3 is elastically deformed. At this time, when the pressing member 2 is pressed downward, the pressing projection 21 of the pressing member 2 will not act on the elastic member 3, and no sound will be generated, so that the pressing function is realized. When applied to the key switch, the key switch is in a silent state.

When the toggle piece 41 is pushed away from the elastic piece 3 (in the reverse direction), the toggle piece 41 releases the force on one end of the elastic piece 3, and one end of the elastic piece 3 is reset under the action of its own elastic restoring force, moving towards the lower part of the pressing projection 21, and finally being below the pressing projection 21. At this time, the pressing piece 2 is pressed downward, and the pressing projection 21 of the pressing piece 2 acts on the elastic piece 3 to generate sound, so that the pressing sound function is realized. When applied to the key switch, the key switch is in a sound state.

The specific sounding principle is as follows: In the process of pressing down the pressing piece 2, the pressing projection 21 on the pressing piece 2 moves down, and the pressing projection 21 acts on one end of the elastic piece 3 downward, and one end of the elastic piece 3 moves down, and when one end of the elastic piece 3 moves down and touches the guide inclined surface 11 on the base 1, it slides outward along the guide inclined surface 11 until one end of the elastic piece 3 is separated from the pressing projection 21, at this time, the hand will feel that the pressing force is obviously reduced, thus generating a hand feeling; At the same time, one end of the elastic member 3 bounces back, knocking on the base 1, the pressing member 2 and/or the poking member 41 to generate sound.

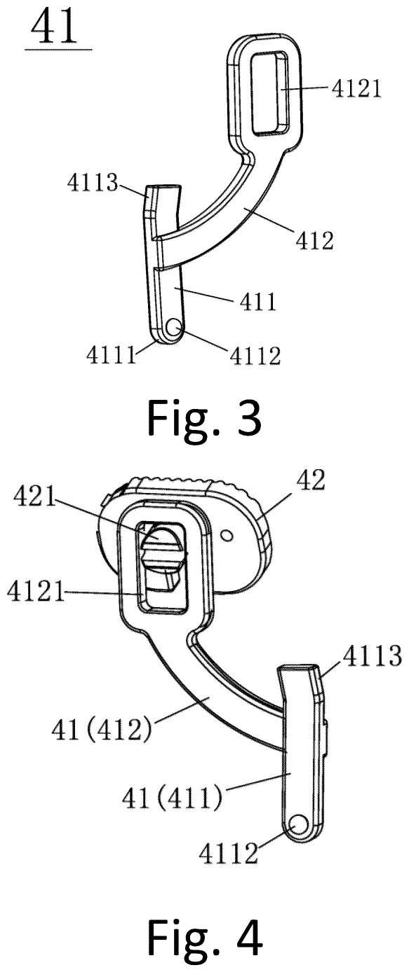

As for the specific structure of the poking piece 41, as shown in FIGS. 1 and 3, the poking piece 41 includes a longitudinal poking rod 411 located at the side of one end of the elastic piece 3, and a linkage swinging rod 412 connected to the longitudinal poking rod 411. The linkage swinging rod 412 serves as a linkage to push the longitudinal poking rod 411 forward and backward, so that the longitudinal poking rod 411 can swing. Specifically, during operation, the linkage swing lever 412 acts toward the elastic member 3, and the linkage swing lever 412 drives the longitudinal shift lever 411 to swing toward the elastic member 3, so that the upper end of the longitudinal shift lever 411 acts on one end of the elastic member 3, and one end of the elastic member 3 moves away from the lower part of the pressing projection 21; On the contrary, the linkage swing lever 412 acts in the direction away from the elastic member 3, and the longitudinal shift lever 411 is driven by the linkage swing lever 412 to swing in the direction away from the elastic member 3, so that the longitudinal shift lever 411 releases the acting force on the elastic member 3, and the elastic member 3 moves below the pressing projection 21 due to the reset.

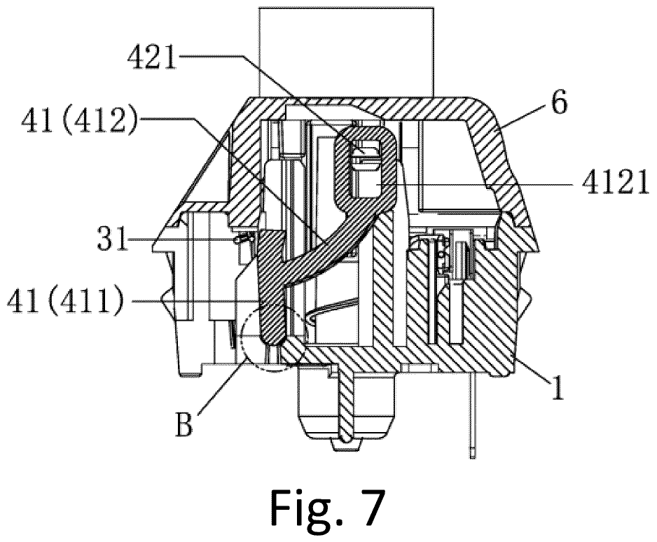

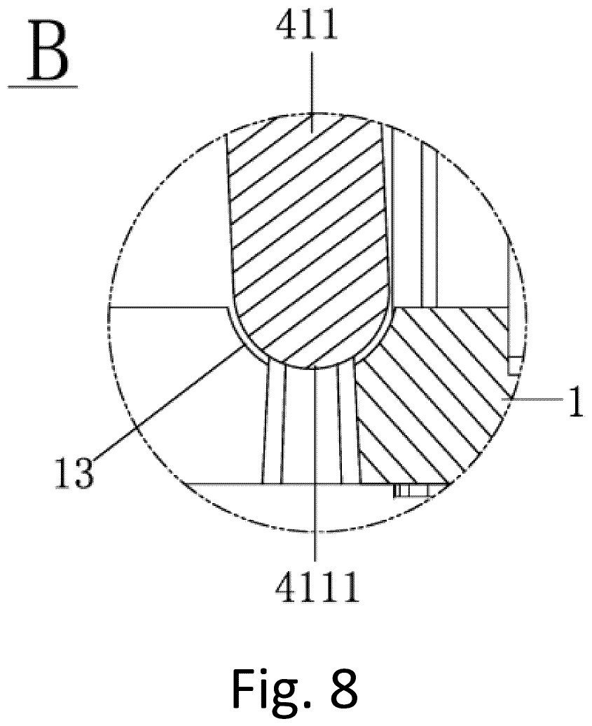

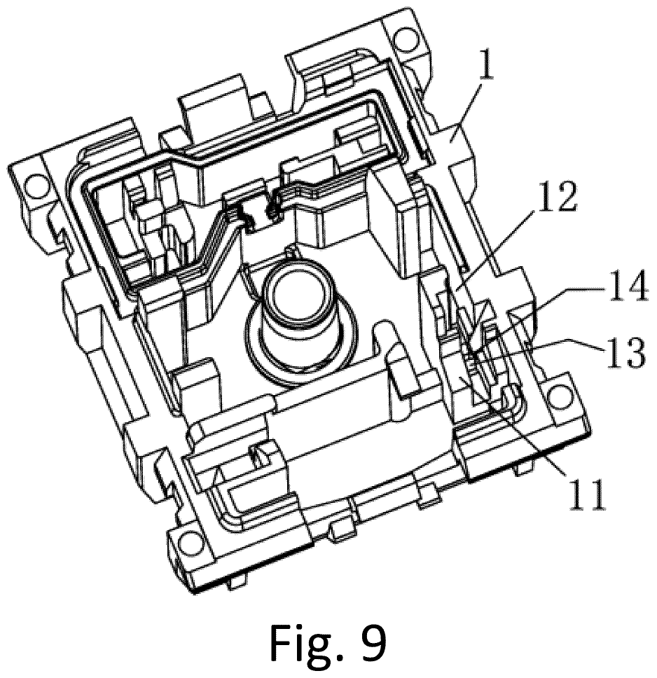

In order to realize the swing of the longitudinal lever 411, as shown in FIG. 3, an arc-shaped part 4111 is formed at the lower end of the longitudinal lever 411 in this embodiment. At the same time, as shown in FIGS. 7 to 9, a longitudinal slot 12 is formed on the base 1 for inserting and moving the toggle member 41, and an arc-shaped swinging slot 13 for embedding the arc-shaped part 4111 of the longitudinal toggle lever 411 is formed in the bottom of the longitudinal slot 12. When the longitudinal shift lever 411 swings in the direction close to and away from the elastic member 3, the fulcrum formed by the matching of the arc-shaped part 4111 at the lower end of the longitudinal shift lever 411 and the arc-shaped swing groove 13 on the base 1 is beneficial to the smooth forward and backward swing of the longitudinal shift lever 411 and the accurate shifting operation of the elastic member 3, so as to realize the switching between audible pressing and silent pressing.

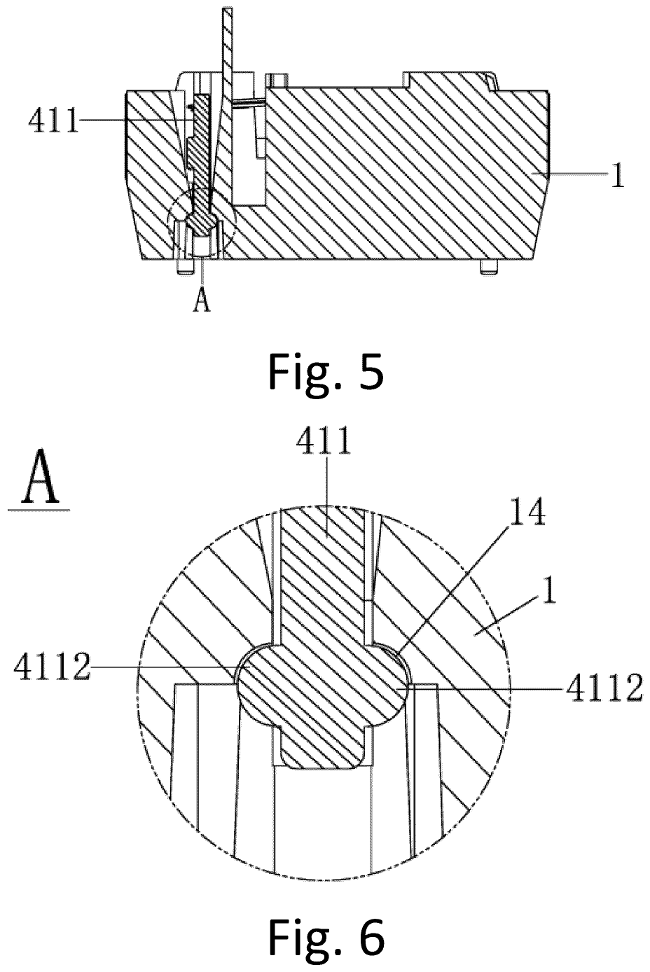

At the same time, as shown in FIG. 3, FIG. 5 and FIG. 6, a limit protrusion 4112 is respectively formed on the two opposite sides of the lower part of the longitudinal shifting lever 411, and the limit protrusion 4112 is located above the arc-shaped part 4111. At the same time, two opposite sides of the arc-shaped swinging groove 13 are respectively formed with a limiting groove 14 into which the limiting protrusion 4112 is embedded. In this embodiment, the direction of the limit protrusions 4112 on both sides of the longitudinal lever 411 is perpendicular to the swinging direction of the longitudinal lever 411. When the longitudinal shifting lever 411 swings back and forth, the limiting protrusion 4112 is matched with the limiting groove 14 to limit the longitudinal shifting lever 411, so as to prevent the longitudinal shifting lever 411 from shifting during the swinging process, so that the longitudinal shifting lever 411 can accurately swing back and forth on a longitudinal plane, which is beneficial to the accurate shifting operation of the elastic piece 3, and thus the switching between audible pressing and silent pressing can be realized.

In order to save internal space, this embodiment can be set to realize the silent pressing function when the longitudinal lever 411 swings to a certain angle in the direction of the elastic member 3; When the longitudinal lever 411 swings to the vertical direction in the opposite direction, it can be separated from the elastic member 3, releasing the function of the elastic member 3, and realizing the sound pressing function. At this time, in order to completely separate the longitudinal lever 411 from the elastic member 3, a yielding slope 4113 is formed on one side of the longitudinal lever 411 close to the elastic member 3 in this embodiment, as shown in FIGS. 3, 4 and 7, the end of the elastic member 3 is yielded, so that the longitudinal lever can be pushed.

In order to facilitate the swinging motion of the longitudinal shift lever 411 after being stressed, the linkage swing lever 412 in this embodiment is arc-shaped as a whole.

In this embodiment, as shown in FIG. 4 and FIG. 7, the toggle switch assembly 4 further includes a push handle 42 linked with a linked swing lever 412. In specific operation, the operator directly acts on the push handle 42, and then the linked swing lever 412 plays a linkage role, and finally pushes the longitudinal swing lever 411 to swing. Specifically, a connecting shaft 421 is arranged on the push handle 42, and a connecting port 4121 for inserting and moving the connecting shaft 421 is arranged at the end of the linkage swing lever 412. The height of the connecting port 4121 is greater than the thickness of the connecting shaft 421, so that the linkage swing lever 412 and the connecting shaft 421 can move relatively, as shown in FIGS. 3, 4 and 7. When the push handle 42 is pushed in the direction of the elastic member 3, the push handle 42 moves horizontally and linearly. In order to cooperate with the movement of the push handle 42, the linkage swing lever 412 will adaptively move upward along the connecting shaft 421 while being pushed forward, thus driving the longitudinal shift lever 411 to swing. On the other hand, when the push handle 42 is pushed in the opposite direction, the push handle 42 also moves horizontally and linearly. In order to cooperate with the movement of the push handle 42, the linkage swing lever 412 will adaptively move down along the connecting shaft 421 while being pushed in the opposite direction, thus driving the longitudinal shift lever 411 to swing.

In this embodiment, the elastic member 3 is a torsion spring 3′, and the torsion spring 3′ has an elastic arm 31, and the end of the elastic arm 31 extends above the guide inclined surface 11, and the end of the elastic arm 31 is toggled by the toggle member 41, so that the end of the elastic arm 31 is switched between being under the pressing projection 21 and being far away from the pressing projection 21.

In order to limit the elastic arm 31 when the pressing piece 2 is not pressed, as shown in FIG. 1, in this embodiment, a limit block 17 is provided on the base 1. When the pressing piece 2 is not pressed, the limit block 17 limits the elastic arm 31 to prevent the elastic arm 31 from bouncing in a large range. At the same time, it is also beneficial for the elastic arm 31 of the torsion spring 3′ to strike the base 1, the pressing member 2 and/or the toggle member 41 more accurately to make sound. At the same time, when the elastic arm 31 of the torsion spring 3′ rebounds, it will also knock on the limit block 17 to make a sound.

In order to facilitate the pressing of the pressing piece 2, a return spring 5 is arranged between the bottom of the pressing piece 2 and the base 1, and the return spring 5 provides elastic restoring force for the pressing piece 2.

In this embodiment, the pressing piece 2 is a guide core, and as shown in FIG. 1, the pressing projection 21 is arranged on the side of the guide core.

When the key switch is in the audible state, during the process of pressing down the guide core, the pressing projection 21 on the guide core moves down, and the pressing projection 21 presses down the elastic arm 31 of the torsion spring 3′, and the elastic arm 31 moves down. When the elastic arm 31 moves down and touches the guide inclined surface 11 on the base 1, it slides outward along the guide inclined surface 11 until the elastic arm 31 is separated from the pressing projection 21. At this time, the hand will feel that the pressing force is obviously reduced. At the same time, the pressing projection 21 rebounds and returns, knocking on the base 1, the pressing piece 2 and/or the pressing switch assembly 4 to generate sound.

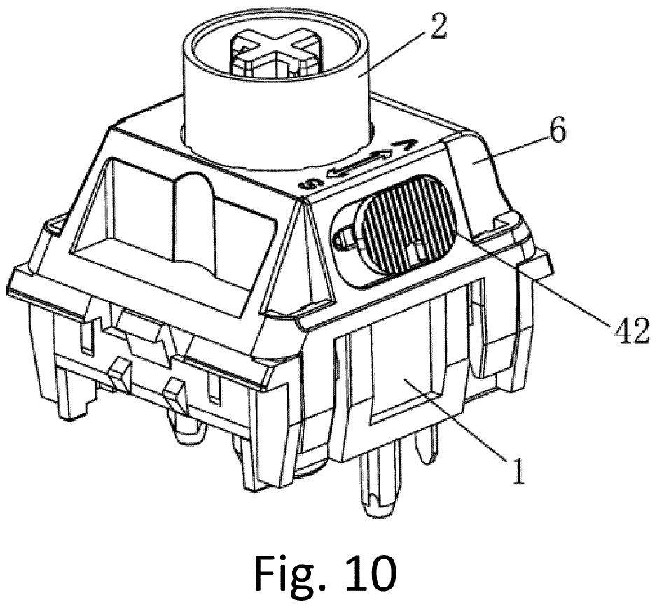

The push-type audible and silent switching mechanism of this embodiment is applied to the key switch. As shown in FIG. 10, when the upper cover 6 is added, the push handle 42 is arranged on the upper cover 6, and corresponding slots are added on the upper cover 6 for the push handle 42 to be embedded, which is beneficial to push the push handle 42 forward and backward. After being pushed in place, the push handle 42 will not move by itself, but will only move when it is acted. At the same time, the conventional mechanical conduction mode or magnetic conduction mode of the moving and static blades is adopted in the key switch, so that the conduction and disconnection functions can be realized.

The above is only a preferred embodiment of the present invention, and does not limit the technical scope of the present invention, so other structures obtained by adopting the same or similar technical features as the above embodiment of the present invention are within the protection scope of the present invention.

What is claimed is:

1. A toggle-type audible and silent switching mechanism for a key switch is characterized by comprising a base and a pressing piece which is arranged on the base and can move up and down, wherein a pressing lug is arranged on the pressing piece, a guide inclined plane is formed on the base, and an elastic piece is arranged on the base, and one end of the elastic piece is positioned above the guide inclined plane. Characterized in that a toggle switching assembly is arranged on the base, and the toggle switching assembly comprises a toggle piece arranged on the base and extending to the side of one end of the elastic piece, and the toggle piece is used for driving one end of the elastic piece to switch between being under the pressing lug and being far away from the pressing lug.

2. The toggle-type audible and silent switching mechanism for a key switch according to claim 1 is characterized in that the toggle piece comprises a longitudinal toggle lever located at one end side of the elastic piece and a linkage swing lever connected to the longitudinal toggle lever.

3. The toggle-type audible and silent switching mechanism for a key switch according to claim 2, the toggle-type audible and silent switching mechanism for key switches is characterized in that an arc-shaped part is formed at the lower end of the longitudinal shifting lever.

4. The toggle-type audible and silent switching mechanism for a key switch according to claim 3 is characterized in that a longitudinal slot for inserting and moving a toggle piece is formed on the base, and an arc-shaped swinging groove for embedding the arc-shaped part of the longitudinal toggle lever is formed at the bottom of the longitudinal slot.

5. The toggle-type audible and silent switching mechanism for a key switch according to claim 4, the toggle-type audible and silent switching mechanism for key switches is characterized in that two opposite side edges of the lower part of the longitudinal shifting lever are respectively formed with a limit projection, and the limit projection is located above the arc part.

6. The toggle-type audible and silent switching mechanism for a key switch according to claim 5, characterized in that a limit groove for embedding a limit protrusion is respectively formed on two opposite sides of the arc-shaped swinging groove.

7. The toggle-type audible and silent switching mechanism for a key switch according to claim 2, the toggle-type audible and silent switching mechanism for the key switch is characterized in that a yielding inclined plane is formed on one side of the longitudinal shifting lever close to the elastic piece.

8. The toggle-type audible and silent switching mechanism for a key switch according to claim 2, the toggle-type audible and silent switching mechanism for a key switch is characterized in that the linkage rocker is in an arc shape as a whole.

9. The toggle-type audible and silent switching mechanism for key switch according to claim 2, characterized in that the toggle-type switching assembly further comprises a push handle linked with the linked swing rod, a connecting shaft is arranged on the push handle, and a connecting port for inserting and moving the connecting shaft is arranged at the end of the linked swing rod, and the height of the connecting port is greater than the thickness of the connecting shaft.

10. The toggle-type audible and silent switching mechanism for a key switch according to claim 1, the toggle switch mechanism for key switch is characterized in that the elastic member is a torsion spring, and a return spring is arranged between the bottom of the pressing member and the base.
